(19) United States
(12) Patent Application Publication
(10) Pub. No.: US 2014/0129240 A1
(43) Pub. Date: May 8, 2014

(54) Health and Exercise Monitoring System and Method Thereof

(71) Applicant: SHENZHEN GOOD FAMILY ENTERPRISE CO., LTD., Shenzhen (CN)

(72) Inventor: JiaXiang Zhang, Shenzhen (CN)

(73) Assignee: SHENZHEN GOOD FAMILY ENTERPRISE CO., LTD., Shenzhen (CN)

(21) Appl. No.: 13/671,525

(22) Filed: Nov. 7, 2012

(51) Int. Cl. G06Q 50/22

(52) U.S. Cl. 705/2

(57) ABSTRACT

An exercise monitoring system that includes a data obtaining unit arranged for gathering a set of health data of a user, a health management unit that communicates with the data obtaining unit, wherein health instruction is provided based on the set of health data provided from the health management unit with the goal of improving the user's health. The health instruction is automatically generated in response to an input from the set of health data. The health management unit includes an interaction unit, wherein a personal trainer of the user interacts with the user to provide the health instruction on a real-time basis.

### BACKGROUND OF THE PRESENT INVENTION

1. Field of Invention

The present invention relates to an exercise monitoring system and method, and more particularly to an exercise monitoring system arranged for obtaining and evaluating a health status of a user in order to give an health instruction in response to a plurality of health index of the user such that the user can follow the health instruction specifically provided based on the health status of the user. The health instruction may be obtained from a personal trainer.

2. Description of Related Arts

There are many different kinds of body health testing equipment on the market. For example, there are testing equipments which measure health data such as blood pressure, heart rate, oxygen saturation, body weight, and body height. These equipment can also collect the health data and translate the health data to a visual display. However, there are some drawbacks to this kind of testing equipment. First, there is a lack of evaluation or automatically generated feedback available in response to the health data. In other words, interpretation of the health data or recommendations are not provided to a user after his or her health status is obtained. Second, there is no correlation between health instruction or suggestion and health status. Based on the health status of a user, an exercise plan cannot be provided, even if appropriate and desirable. In other words, the user cannot make use of the health testing equipment to find out the type of exercise which is specifically appropriate for his or her health conditions. Third, there is lack of continuous monitoring of the health status of the user; in particular, the test or measurement runs on a one-time basis. The health status of the user over a period of time is not stored in the equipment and there is no way to compile or organized the health data automatically in a systematic manner. Fourth, there is lack of portability or mobility of the health data. The health data is obtained in a particular location through the health testing equipment and the health data is not available when the user goes to exercise at another location. If the user goes to different locations of a chain fitness centre, the health data cannot be retrieved in any way. Fifth, the user may ask a fitness trainer or gym instructor for advice, but the user has to go to the fitness centre. In addition to a convenience factor, the cost of a personal fitness trainer can be substantial. In other words, it is not convenient for the user to have real-time instruction when the fitness trainer or gym instructor is not by his or her side. In summary, the user cannot make use of the health data obtained through the health testing equipment in a practical and convenient way for health improvement.

Health data is useful to determine the type and duration of exercise desirable and suitable for a user. However, the health status of an individual will change over time and the health data obtained from a one-time single test may not be able to accurately reflect the current health status of an individual. For example, if an individual who relies on the health data at a particular time and implements an exercise plan based on that particular reading, his body's conditions will then change over time based on his exercise level and body's reaction. Without feedback data of the particular individual, the exercise plan may no longer be fit or suitable for the particular individual. In other words, an interactive health data of the individual is required to closely and accurately monitor the health status of the individual.

People have always had the misconception that exercise is good for health regardless of the level. In general, excessive exercise is harmful and inadequate exercise is not effective. There is no existing tool which is able to help a human user determine the correct type of exercise and whether the correct exercise level is achieved. The only available method for the individual is to rely on his or her own feelings, which is a very poor, if not dangerous, control method and may impose health hazards to the individual. In other words, there is no real-time monitoring available for the individual.

### SUMMARY OF THE PRESENT INVENTION

An object of the present invention is to provide an exercise monitoring system which can effectively monitor health data of a user on an exercise equipment so as to determine a health status of the user and provide reference health data for controlling the exercise equipment.

Another object of the present invention is to provide an exercise monitoring system which includes a health monitoring apparatus for obtaining, storing and transmitting the health data of a user on exercise equipments. This health data is then used to generate a health status and health instructions for the exercise equipments in response to the health data at a particular time.

Another object of the present invention is to provide an exercise monitoring system which includes a health monitoring apparatus for collecting, providing, and transmitting the health data of a user of an exercise equipment in order to provide feedback information and suggestion regarding what exercise level and intensity for the user to operate, which exercise to use, and what level or type of exercise trainer the user may use.

Another object of the present invention is to provide an exercise monitoring system which includes a health monitoring apparatus for obtaining, storing and transmitting the health data of a user on exercise equipments in order to generate referral information of what kind of exercise device is recommended for the user.

Another object of the present invention is to provide an exercise monitoring system which includes a control module, a health monitoring apparatus for obtaining the health data of a user and communication with the control module, a health evaluation module for communicating with the control module arranged to analyze the health data, a feedback module for generating health instruction, and a communication module for communicating with the control module and transmitting the health instruction to a preset location such as the health monitoring apparatus.

Another object of the present invention is to provide an exercise monitoring system for guiding a user to exercise in a proper and safe manner.

Another object of the present invention is to provide an exercise monitoring system for promoting exercise through providing health instruction which offers clear guidance to a user to exercise in a proper and safe manner.

Another object of the present invention is to provide an exercise monitoring system which can encourage a user to implement a self-help health improvement program in a proper and safe manner through providing health instruction in response to his or her current health condition.

Another object of the present invention is to provide an exercise monitoring system which enables a human user to interact with a personal trainer, and to receive real-time health instruction from the personal trainer.

Another object of the present invention is to provide an exercise system, wherein the health data of the user can be stored and updated, so that the health instruction for the next exercise session can be provided with respect to the updated health data.

Another object of the present invention is to provide an exercise monitoring system which enables the user to store and update his or her health data so as to build up a health history. The user may improve his or her health condition by following the health instructions based on the health history.

Another object of the present invention is to provide a business method, wherein a personal trainer can remotely monitor the health and exercise of the user of the exercise equipment through the exercise monitoring system and give advice when necessary.

Another object of the present invention is to provide a business method which enables the user to choose his or her desired personal trainer at a any distance from them.

Another object of the present invention is to provide a business method beneficial for the user of the exercise equipment, seller of the exercise equipment, and the personal trainer of the user.

Additional advantages and features of the invention will become apparent from the description which follows, and may be realized by means of the instrumentalities and combinations particular point out in the appended claims.

In order to accomplish the objects mentioned above, the present invention provides an exercise monitoring system which includes a health monitoring apparatus arranged for obtaining a set of health data of a user, comprising:

a health control unit that interactively communicates with the health monitoring apparatus, arranged for receiving the set of health data of the object, analyzing the health data and generating an health instruction for the user,

wherein the health control unit is linked with a plurality of health statuses, wherein each one of the health status is arranged to reflect one particular set of health data and is correlated to one particular health instruction, comprising:

a central processing unit for receiving the set of health data, an evaluation module for analyzing the set of health data to provide the health status for the user, a feedback module for receiving the health status and providing the health instruction, and a communication module for receiving the health instruction and communicating with the central processing unit arranged for translating the health instruction to a communication unit on a real-time basis.

Preferably, the health control unit and the monitoring apparatus are located in two different locations and remotely communicate with each other. The communication unit is a display unit incorporated into the monitoring apparatus arranged to visually display the health instruction to the user, or is a standalone device that remotely communicates with the health control unit arranged for communicating the health instruction to the user.

In particular, the health instruction of the feedback module comprises a plurality of exercise items, and each of the exercise items includes the name and duration of the exercise. The health control unit further comprises an input terminal connecting to the central processing unit, whereby the user is capable of inputting profile and preference data into the health control unit. The feedback module is capable of processing the health status together with the profile and preference data before providing the health instruction. The health monitoring apparatus comprises a plurality of sensor units and a sensor module, and each of the sensor units generate and send the corresponding health data to the health control unit. The plurality of sensor units comprise of a blood pressure sensor, a body temperature sensor, heart rate sensor, body weight sensor, a balancing ability sensor, a bone density sensor and a hand-grip sensor. The health data include blood pressure, body temperature, heart rate, body weight, balancing ability, bone density and hand-grip data.

In accordance with another aspect of the invention, the present invention comprises an exercise monitoring method which employs a health monitoring apparatus and a health control unit, comprising the following steps.

(a) Generate a set of health data of a user through the health monitoring apparatus.

(b) Interactively and remotely communicate the health monitoring apparatus with the health control unit, which is linked with a plurality of health statuses, wherein each one of the health status is arranged to reflect one particular set of health data and is correlated to one particular health instruction.

(c) Transmit the set of health data of the user to the health control unit.

(d) Analyze the set of health data and provide the health status for the user.

(e) Generate an health instruction for the user.

(f) Communicate the health instruction to the user on a real-time basis.

Preferably, the method further comprises the steps of: (i) input and creation of profile data for the user before step (a); (ii) link the profile data with the health data such that the profile data and the health data are stored and retrievable by the user after step (c); (iii) input and add the preference data to the profile data for the user after step (i); and (iv) process the health status together with the profile data and the preference data before the step (d).

In addition, after step (f), the method further comprises the following steps:

(g) Feed an exercise data of the user to the health control unit.

(h) Analyze the exercise data and the health data together and generate a second health instruction.

(j) Communicate the second health instruction to the user on a real-time basis.

(k) Feed a second health data of the user to the health control unit.

(l) Analyze the second health data and the first health data together and generate the next health instruction.

(m) Communicate the next health instruction to the user on a real-time basis.

In accordance with another aspect of the present invention, the present invention provides an exercise monitoring system comprising: a data obtaining unit arranged for obtaining a set of health data of a user, and a health management unit for communicating with the data obtaining unit for receiving the set of health data, wherein a health instruction is provided based on the set of health data through the health management unit for improving health of the user.

According to one embodiment of the present invention, the health management unit is linked with a plurality of health statuses, wherein each one of the health status is arranged to reflect one particular set of health data and is correlated to one the particular health instruction, wherein the health instruction is automatically generated in response to an input of the set of health data.

According to another embodiment of the present invention, the health management unit comprises of an interaction unit, wherein a personal trainer for the user interacts with the user to provide the health instruction.

In accordance with another aspect of the present invention, the present invention provides an exercise monitoring method comprising the following steps.

(a) Generate a set of health data for a user through a data obtaining unit.

(b) Interactively link the data obtaining unit with a health management unit, wherein the health monitoring unit is used for providing a health instruction based on the set of health data.

In accordance with another aspect of the present invention, the present invention provides a business method for at least one; user of the exercise equipment, seller of the exercise equipment, and a personal trainer of the user, wherein the method comprises the following steps.

(I) Provide the exercise equipment and an exercise monitoring system for the user by the seller of the exercise equipment.

(II) Link the exercise equipment with an exercise monitoring system, wherein the user logs into the exercise monitoring system and obtains a set of health data of the user, generated from use of the exercise equipment.

(III) Associate the user with the personal trainer in such a manner that a real-time diagnosis or heal instruction, based on the set of health data, is provided to the user by the personal trainer.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view illustrating the interaction of a user with an exercising monitoring system and a personal trainer according the present invention.

FIG. 2 is a schematic illustration of an exercise monitoring system according to a preferred embodiment of the present invention.

FIG. 3 is an exemplary illustration of the exercise monitoring system according to the above preferred embodiment of the present invention.

FIG. 4 is another exemplary illustration of the exercise monitoring system according to the above preferred embodiment of the present invention.

FIG. 5 is a flow chart of an exercise control process according to an exemplary embodiment of the above preferred embodiment of the present invention.

FIG. 6 is a schematic view of an exercise monitoring system according to a second preferred embodiment of the present invention.

FIG. 7 is a schematic view of an alternative mode of the exercise monitoring system according to the above second preferred embodiment of the present invention.

FIG. 8 is a schematic view illustrating the operation principle of the exercise monitoring system according to the above second preferred embodiment of the present invention.

FIG. 9 a flow chart of an exercise control process of the exercise monitoring system according to the above second preferred embodiment of the present invention.

FIG. 10 a flow chart of an exercise control process of the exercise monitoring system according to alternative mode of the above second preferred embodiment of the present invention.

FIG. 11 is a schematic view illustrating a business mode according to the above second preferred embodiment of the present invention.

### DETAILED DESCRIPTION OF THE PREFERRED EMBODIMENT

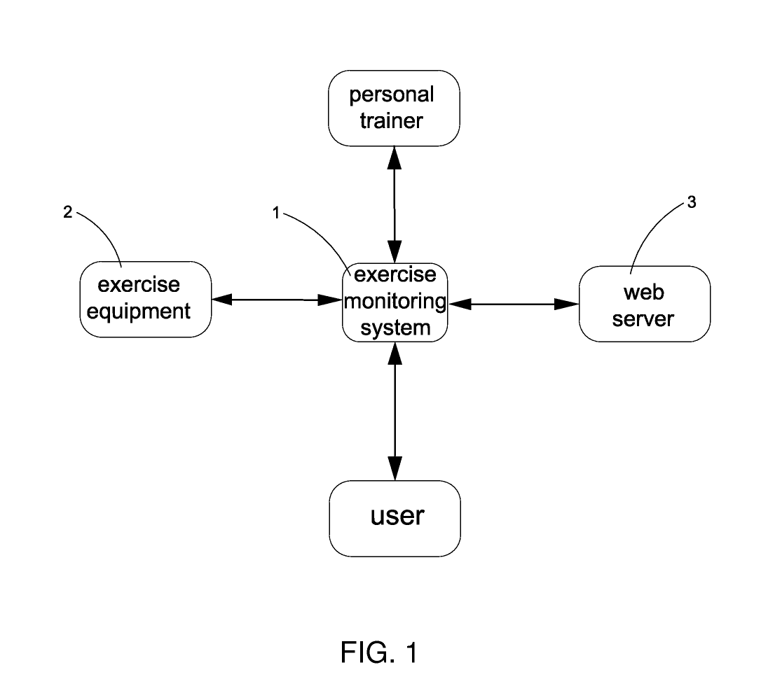

Referring to FIG. 1 of the drawings, an exercise monitoring system 1 is introduced for guiding the user to do exercise with exercise equipment 2. Accordingly, a health instruction is provided via exercise monitoring system 1 so that the user may follow the health instruction to improve the health condition of the user.

More specifically, the health instruction may be directly provided by exercise monitoring system 1. In other words, the health instruction is directly generated by exercise monitoring system 1 which serves as a database for generating a feedback to a set of health data of the user.

Accordingly, the user exercises with exercise equipment 2 and obtains a set of health data including exercise data or physical parameters recommended by exercise equipment 2, and then the health instruction is provided based on the set of health data. In particular, exercise monitoring system 1 contains a plurality of health statuses. Each one particular health status is arranged for reflecting one particular set of health data and is correlated to one particular health instruction, wherein the health instruction is automatically generated in response to an input of the set of health data.

Alternatively, the exercise monitoring system severs as a medium for interaction between the user and a personal trainer. In other words, when a user obtains a set health data after doing exercise with exercise equipment 2, he or she can inform the personal trainer with the help of exercise monitoring system 1, so that the personal trainer can give advice to the user. It is recognizable that the communication manner between the personal trainer and the user of the exercise equipment may be telephone call, video chat, or SMS. Preferably, the interaction between the personal trainer and the user of the exercise equipment is a real-time communication. Correspondingly, exercise monitoring system 1 is installed with communication equipments such as a network connection module, a microphone, a camera, and etc.

Accordingly, exercise monitoring system 1 can be incorporated into exercise equipment 2 for directly receiving the set of health data from exercise equipment 2. Alternatively, exercise monitoring system 1 is physically separated from exercise equipment 2, but the set of health data generated by exercise equipment 2 when the user exercises with exercise equipment 2 can be transmitted to exercise monitoring system 1 with a wireless connection. Alternatively, the set of health data may be manually input into exercise monitoring system 1, and stored and updated in database of exercise monitoring system 1. When exercise monitoring system 1 is a health instruction provider, a corresponding health instruction is generated in response of the input of the set of health data.

It is worth mentioning that a set of health data is stored and updated in the exercise monitoring system after each exercise of the user, so that a history of the health data is built up in the exercise monitoring system for the user to review and thus the user may adjust his exercise plan according to the history. This is unexpected in the state of the art and is particularly beneficial for improving the health condition of the user.

Accordingly, the user registers in exercise monitoring system 1 with a user account. Thus the user may login in exercise monitoring system 1 with a username and password. Alternatively, the user may use a portable flash memory, a membership card, a QRCode card, and etc. to login into the exercise monitoring system. In addition, physical features of the user such as fingerprint and cornea may also be employed. It is worth mentioning that the set of health data and related health instructions may be downloaded to a portable storage device and is kept by the user.

Furthermore, web server 3 may be introduced to facilitate the storing and updating of the health data. In other words, exercise monitoring system 1 communicates with web server 3 in a wired connection or wireless connection. The set of heat data can be uploaded to web server 3 and the user may user a terminal to login in exercise monitoring system 1 and have access to web server 3 to download the health information. Accordingly, the user may use a same user account to have access to web server 3 with a portable computer, cell phone, or PDA.

It is still worth mentioning that a database of health instructions related to the corresponding set of health data is stored in web server 3 and thus the user may actually receive the health instruction from web server 3. In addition, web server 3 can be updated with information such as a particular health instruction being found to be effective for a predetermined set of health data.

It is noteworthy that the profile data of the personal trainer, which is a fitness trainer, an exercise instructor, a doctor, a personal nursing, or an expert of exercise equipment 2, is also stored in web server 3. It is recognizable that a set of profile data related to a plurality of personal trainers is stored in web server 3. The user can choose his or her desired personal trainer after reviewing the profile data.

The health instruction from the personal trainer with the help of exercise monitoring system 1 is especially effective for its real-time basis. In other words, the personal trainer interacts with the user with his/her experience in real-time, and thus the user can adjust his/her exercise plan immediately. When necessary, the personal trainer also can retrieve the history of the health data stored in web server 3 or the exercise monitoring system 1 and then give a series of health instruction based on the exercise history of the user.

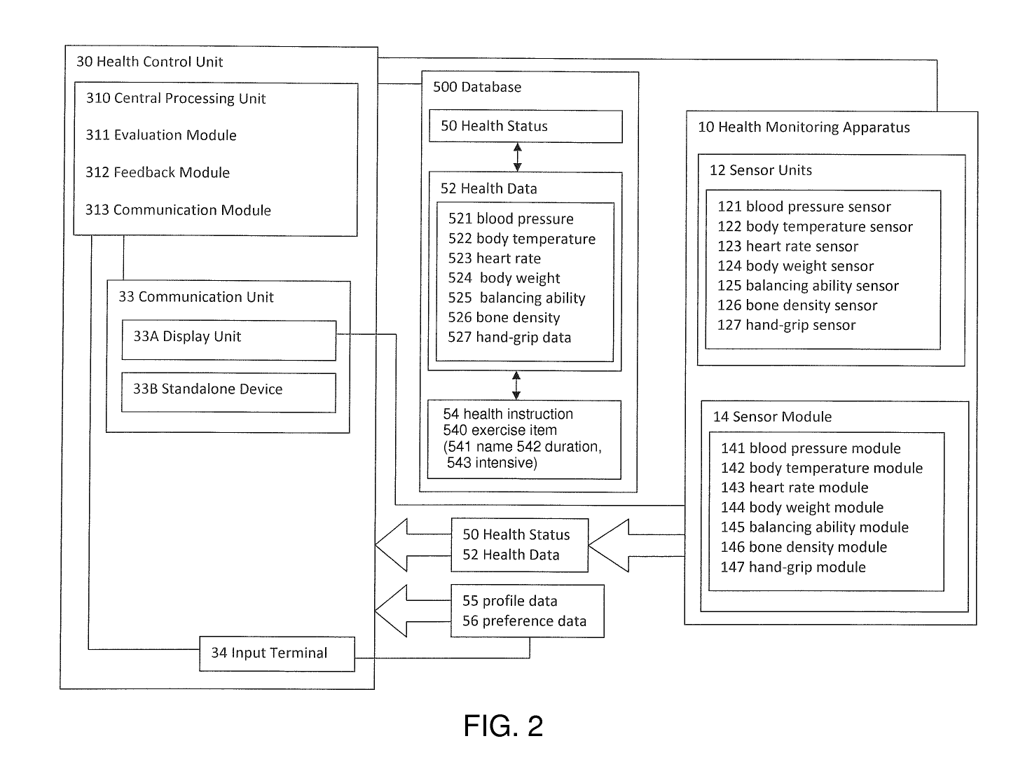

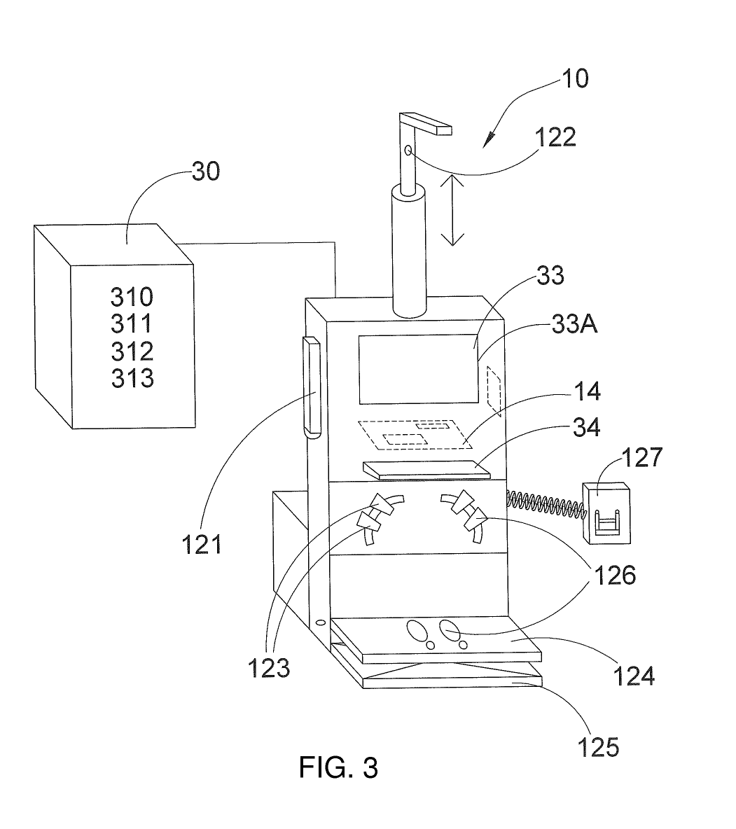

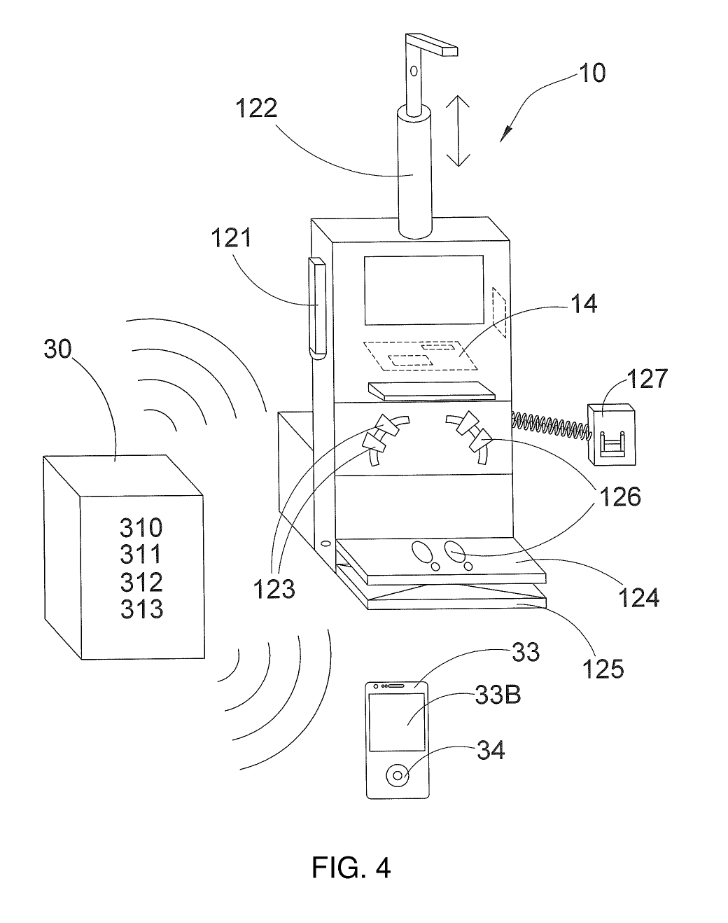

Referring to FIGS. 2 to 5 of the drawings, an exercise monitoring system according to a preferred embodiment of the present invention includes health monitoring apparatus 10 and health control unit 30. The exercise monitoring system is used to actively monitor health status 50 of a user at a particular time. Health control unit 30 interactively communicates with health monitoring apparatus 10, arranged for receiving the set of health data 52 of the user via a web based health data provider through internet, by connecting with an electronic memory unit such as a smart phone, PDA, tablet PC, notebook computer, portable hard drive, SD card or flash memory, or by manual input from the user. Health Data 52 is then analyzed and health instructions and information is generated for the user. Accordingly, the user can follow health instruction 54 which includes, but not limited to, the suitable type of exercise and the exercise equipment to be used, the exercise level and intensity of the exercise, and duration of the exercise without subjective personal determination. In addition, exercise information 54 generated could also provide information and suggestion regarding what level or kind of exercise the user may use.

In particular, health control unit 30 is linked to database 500 containing a plurality of health statuses 50. Each one particular health status 50 is reflective of one particular set of health data 52 and is correlated to one particular health instruction 54. Database 500 can be locally or remotely connected to the health control unit 30. Preferably, health instruction 54 is automatically generated by health control unit 30 in response to health data 52 received.

It is worth mentioning that health control unit 30 can also be accessed by a practitioner or exercise trainer and can override the instructions to health control unit 30. In other words, the practitioner or exercise trainer can review the health data 52 and select alternative health instruction 54 for the user.

Health control unit 30 includes central processing unit 310 that receives the set of health data 52, evaluation module 311 that analyzes the set of health data 52 to provide health status 50 for the user; feedback module 312 that receives health status 50 and provides health instruction 54; and communication module 313 that receives health instruction 54 and communicates with central processing unit 310 arranged for translating health instruction 54 to communication unit 33, embodied as on a real-time basis.

In particular, a plurality of health indexes, such as blood pressure, body temperature, heart rate, body weight and height, balancing ability, and bone density are used for health assessment in order to generate health instruction 54. Preferably, health monitoring apparatus 10 comprises a plurality of sensor units 12 and a sensor module 14. Each of the sensor units 12 is able to generate and send the corresponding health data 52 to health control unit 30. Preferably and in particular, the plurality of sensor units 12 can be selected from a group comprising, but not limited to, a blood pressure sensor 121, body temperature sensor 122, heart rate sensor 123, body weight sensor 124, balancing ability sensor 125, bone density sensor 126, and hand-grip sensor 127. Sensor module 14 for each of the sensor units 12 can be selected from a group comprising, but not limited to, blood pressure sensor module 141, body temperature sensor module 142, heart rate sensor module 143, body weight sensor module 144, balancing ability sensor module 145, bone density sensor module 146, and hand-grip sensor module 147 respectively. It is worth mentioning that all the sensor modules 14 (141-147) can also be an integrated module serving the same purpose.

Accordingly, health data 52 is preferred to include blood pressure 521, body temperature 522, heart rate 523, body weight 524, balancing ability 525, bone density 526 and hand-grip data 527. Therefore, health data 52, which contains data of different health indexes, can be used for comprehensive health assessment, serving as a reliable basis for the health instruction. The safety level of having an exercise plan is therefore greatly increased.

Communication unit 33 is display unit 33A incorporated into monitoring apparatus 10, arranged to visually display health instruction 54 to the user. Alternately, communication unit 33 is a standalone device 33B that remotely communicates with health control unit 30, arranged to communicate health instruction 54 to the user. It is worth mentioning that communication unit 33 is not limited to providing visual display and it is possible to provide health instruction 54 in an audio format. The visual or audio display of monitoring apparatus 10 can be installed to the exercise equipment of the user so that the user may receive and access health instruction 54 during exercise.

The generated health instruction 54 may also include information regarding the suitable type of exercise and the exercise equipment to be used, the exercise level and intensity of the exercise and the exercise equipment to be used, and duration of the exercise and the exercise equipment to be used without subjective personal determination. In addition, the exercise information 54 generated could also provide information and suggestion regarding what level or kind of practitioner or exercise trainer the user may use.

Preferably, health control unit 30 and monitoring apparatus 10 are located in two different locations and remotely communicate with each other. For example, health data 52 can be sent from monitoring apparatus 10 to a remotely positioned health control unit 30 for data processing, and health instruction 54 may be retrieved from display unit 33A of monitoring apparatus 10 or from standalone device 33B. It is worth mentioning that standalone device 33B may be a handheld device, a PDA, a tablet, a cellular phone, a smart phone, a notebook computer, or even exercise equipment.

Preferably, health instruction 54 of feedback module 312 comprises a plurality of exercise items 540, and each of exercise items 540 includes the name of exercise or exercise equipment 541 and duration of exercise or exercise equipment 542. Accordingly, the user can follow exercise items 540 to implement his or her exercise plan based on his or her own particular health status 50. The user is now clear about the type and duration of exercise which is effective and safe for his or her wellness. In other words, the incentive of exercising is greatly increased and the probability of exercise becomes higher.

The generated health instruction 54 can be electronic signals transmitted to the control units of one or more exercise equipments of the user, in a wired or wireless linking manner, so as to control the exercise level, operation, and intensity of the exercise equipment with respect to the user's current health data.

Health control unit 30 further comprises input terminal 34 connecting to central processing unit 310, whereby the user is capable of inputting profile data 55 and preference data 56 into health control unit 30 and feedback module 312 is capable of processing health status 50 together with profile data 55 and preference data 56 before providing health instruction 54.

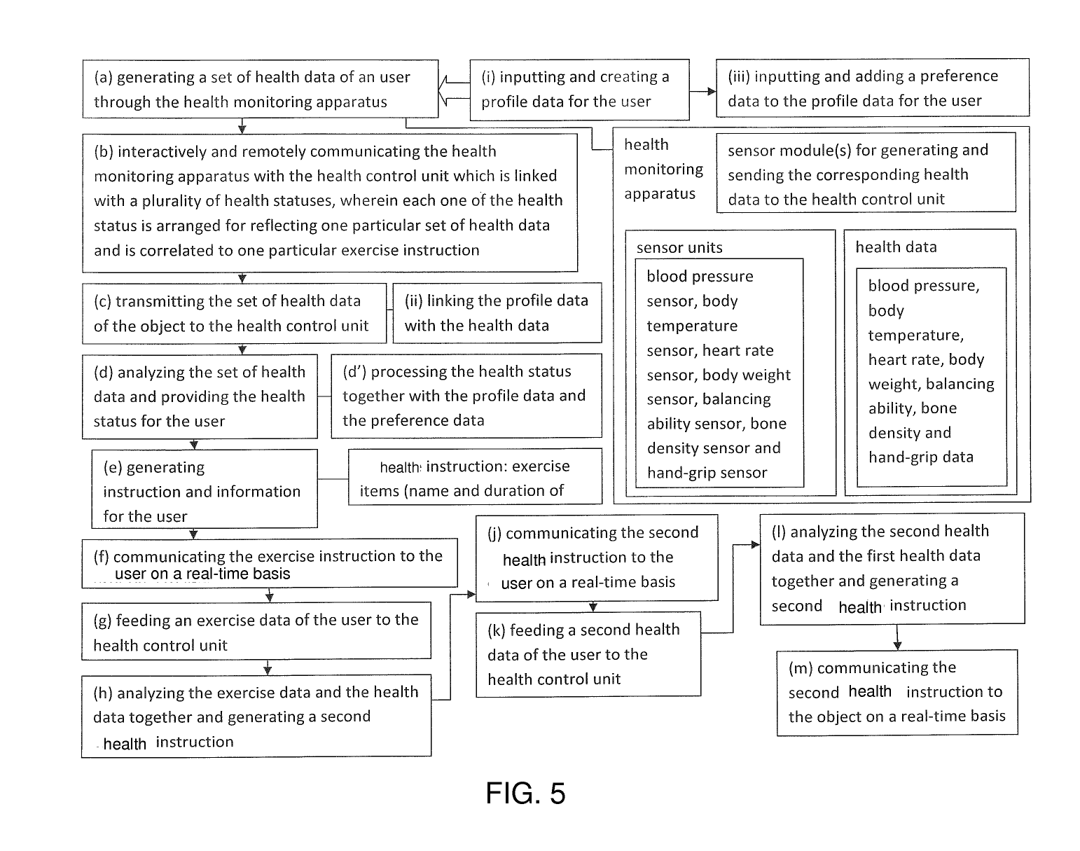

Referring to FIG. 5 of the drawings, an exercise monitoring method which employs a health monitoring apparatus and a health control unit according to the preferred embodiment of the present invention is illustration. In particular, the method comprises the following steps:

(a) Generate a set of health data of the user through the health monitoring apparatus;

(b) Interactively and remotely communicate the health monitoring apparatus with the health control unit which is linked with a plurality of health statuses, wherein each one of the health status is arranged to reflect one particular set of health data and is correlated to one particular health instruction;

(c) Transmit the set of health data of the user to the health control unit;

(d) Analyze the set of health data and provide the health status for the user;

(e) Generate an health instruction for the user; and

(f) Communicate the health instruction to the user, preferably on a real-time basis.

In particular, a plurality of health indexes, such as blood pressure, body temperature, heart rate, body weight and height, balancing ability and bone density are used for health assessment in order to generate health instruction 54. Preferably, health monitoring apparatus 10 is embodied to comprise a plurality of sensor units 12 and sensor module 14. Each of the sensor units 12 is able to generate and send corresponding health data 52 to health control unit 30. Preferably and in particular, the plurality of sensor units 12 may comprise of blood pressure sensor 121, body temperature sensor 122, heart rate sensor 123, body weight sensor 124, balancing ability sensor 125, bone density sensor 126, and hand-grip sensor 127. Sensor module 14 for each of sensor units 12 are blood pressure sensor module 141, body temperature sensor module 142, heart rate sensor module 143, body weight sensor module 144, balancing ability sensor module 145, bone density sensor module 146, and hand-grip sensor module 147 respectively. It is worth mentioning that all sensor modules 14 (141-147) can also be an integrated module serving the same purpose.

Accordingly, health data 52 is preferred to include, but not limited to, blood pressure 521, body temperature 522, heart rate 523, body weight 524, balancing ability 525, bone density 526, and hand-grip data 527. Therefore, health data 52, which contains data of different health indexes, can be used for comprehensive health assessment and serves as a reliable basis for the health instruction. The safety level of having an exercise plan is therefore greatly increased.

Preferably, the method further comprises the steps of (i) Input and creation of profile data 55 for the user before step (a) and (ii) Link profile data 55 with health data 52 such that profile data 55 and health data 52 are stored and retrievable by the user after step (c). In other words, the particular profile data 55 of a user is stored through health control unit 30. When the user uses health monitoring apparatus 10 over a period of time, health data 52 for the particular user will be evaluated together to provide health instruction 54.

Preferably, the method further comprises the steps of: (iii) Input and addition of preference data 56 to profile data 55 for the user after step (i); and process health status 50 together with profile data 55 and preference data 56 before the step (d). For example, preference data 56 may contain preferred type of exercise equipment or preferred duration of exercise, and then health instruction 54 is filtered and altered to fit the preference of the user.

Preferably, after step (f), the method is preferably to further comprise the steps of:

(g) Feed the exercise data of the user to the health control unit;

(h) Analyze the exercise data and the health data together and generate a second health instruction; and

(i) Communicate the second health instruction to the user, preferably on a real-time basis.

Also, after the step (f), the method is preferred to further comprise the steps of:

(j) Feed a second health data of the user to the health control unit;

(k) Analyze the second health data and the first health data together and generate a second health instruction; and

(l) Communicate the second health instruction to the user, preferably on a real-time basis.

Preferably, health instruction 54 of feedback module 312 comprises a plurality of exercise items 540, and each of exercise items 540 includes a name of exercise or exercise equipment 541, duration of exercise or exercise equipment 542 and intensity of the exercise or the exercise equipment, such as exercise level, operation and intensity of exercise equipment 543. Accordingly, the user can pick one of exercise items 540 and follow the selected exercise item 540 to implement his or her exercise plan based on his or her own particular health status 50. The user is now clear about the type of exercise or exercise equipment, and the duration and intensity of exercise or exercise equipment which is effective and safe for his wellness. In other words, the incentive of exercising is greatly increase and the probability of exercise becomes greater. For example, exercise items 540 may includes “swimming for 30 minutes”; “jogging for 25 minutes on a treadmill at a speed 5 miles per hour”; “X-machine quick start for 25 minutes” (X refers to a name of a gym equipment), and the like. Then the user may pick one based on his or her preference. It is worth mentioning that the user preference can also be entered into health control unit 30 and the display priority of the exercise items 540 will be changed based on preference data 56.

As mentioned above, the method of the present invention may further comprises a step of transmitting the health instruction generated to exercise equipment via electronic signals, in a wired or wireless linking manner, for controlling the exercise level, operation and intensity of the exercise equipment with respect to the user's current health data.

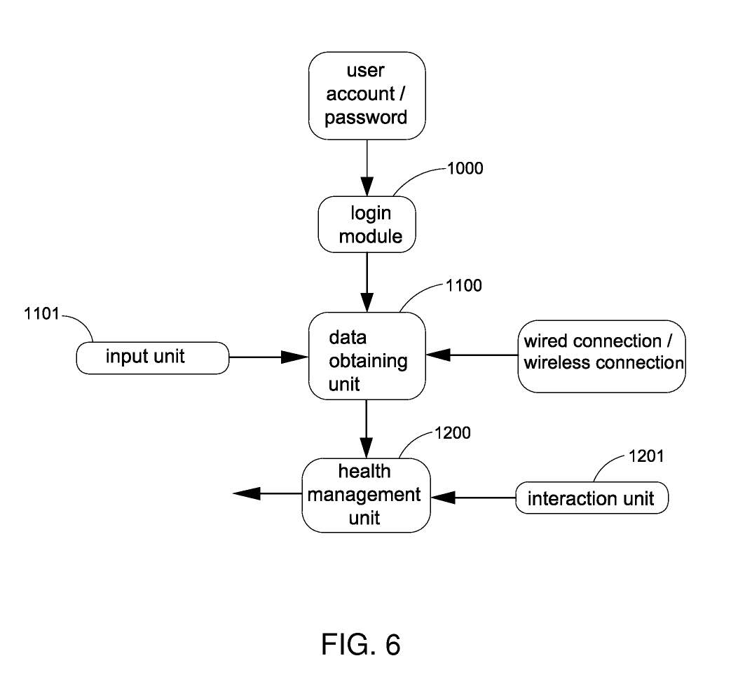

Referring to FIGS. 6 to 10 of the drawings, an exercise monitoring system according to a second preferred embodiment of the present invention is illustrated. In the following disclosure, the mentioned exercise item is selected from the group consisting of, but not limited to, a rowing machine, fitness bike, walking machine, treadmill, waist machine, and a physical testing machine that adjusts operation parameter during operation.

Referring to FIG. 6 of the drawings, the exercise monitoring system comprises login module 1000, data obtaining unit 1100 for obtaining a set of health data, and health management unit 1200. In this preferred embodiment, health management unit 1200 is a health instruction generating unit. Health management unit 1200 is linked with a plurality of health statuses, wherein each one of the health status is arranged to reflect one particular set of health data and is correlated to one particular health instruction, wherein the health instruction is automatically generated in response to an input of the set of health data.

Accordingly, the exercise monitoring system can be incorporated with an application software which can be installed into a cell phone, exercise equipment or a PDA to provide health consultation. The inquiry and management of health data of the user can be realized with a simple and convenient operation.

The user may have access to the exercise monitoring system through the login module 1000 by inputting a username and password. Accordingly, an account with the username and password can be obtained by registering. Alternatively, other human physical features such as fingerprint or cornea, may be used for logging into the exercise system. Alternatively, the user can log in by means of electronic devices such as a membership card, a QRCode, or a flash memory device.

Data obtaining unit 1100 can have access to health data such as the initial exercise data and physical parameters of the user through the user account. Alternatively, input unit 1101 may be provided so that the user may manually input the initial exercise data and physical parameters into input unit 1101. It is worth mentioning that the initial exercise data and physical parameters may be obtained in a wired or wireless linking manner according to practical requirements. For example, a network connection unit such as a wired network connection module, a near field communication module, a Bluetooth module or a WIFI module may be provided for this concern. Furthermore, the data obtaining unit 1100 may also obtain lifestyle information of the user such as schedule, food preference, labor intensity, and transportation means besides the initial exercise data and physical parameters.

Health management unit 1200, which is embodied as a health instruction generating unit, generates health instruction based on the initial exercise data and physical parameters. The user can exercise or adjust their diet, schedule, and living habit under the guidance of the health instruction, so that an effective health monitoring system is built up. In addition, health management unit 1200 is provided with interaction unit 1201 through which the user may interact with a personal trainer for real-time consultation or diagnosis. The personal trainer can be a fitness trainer, exercise instructor, or an expert of the exercise equipment so that personal and effective health instructions are respectively provided for users with different requirements and in different health conditions. As mentioned above, the health instructions can be made with respect to the living habit. For example, when the transportation means is driving an adjustment in regard to eye exercise, reaction ability, and intensity of exercise are made according to different requirements.

In addition, health management unit 1200 may serve as an evaluation system for evaluating each health data of the user. The evaluation result and the advice of the personal trainer may both be incorporated for providing the health instruction.

In this preferred embodiment, the user may update his or her initial exercise data and physical parameters as long as available. The initial exercise data may be any operating parameters of the exercise equipment such as velocity, resistance, duration or energy consumption. Of course, the initial exercise data can also be exercise parameters of the user such as number of push-ups, number of pull-ups, duration of running, or duration of swimming. The physical parameters refer to parameters such as gender, height, weight, body fat ratio, cardiac function, medical history and so on. The mentioned initial exercise data and the physical parameters are systematic and organized and managed, so that intelligent, systematic, and effective monitoring of the health of the user can be achieved.

Accordingly, the embodiment of the present invention keeps track of and manages the initial exercise data and physical parameters through setting up the user account. Data obtaining unit 1100 and health management unit 1200 effectively serve to scientifically manage the health of the user and build up a scientific exercising system.

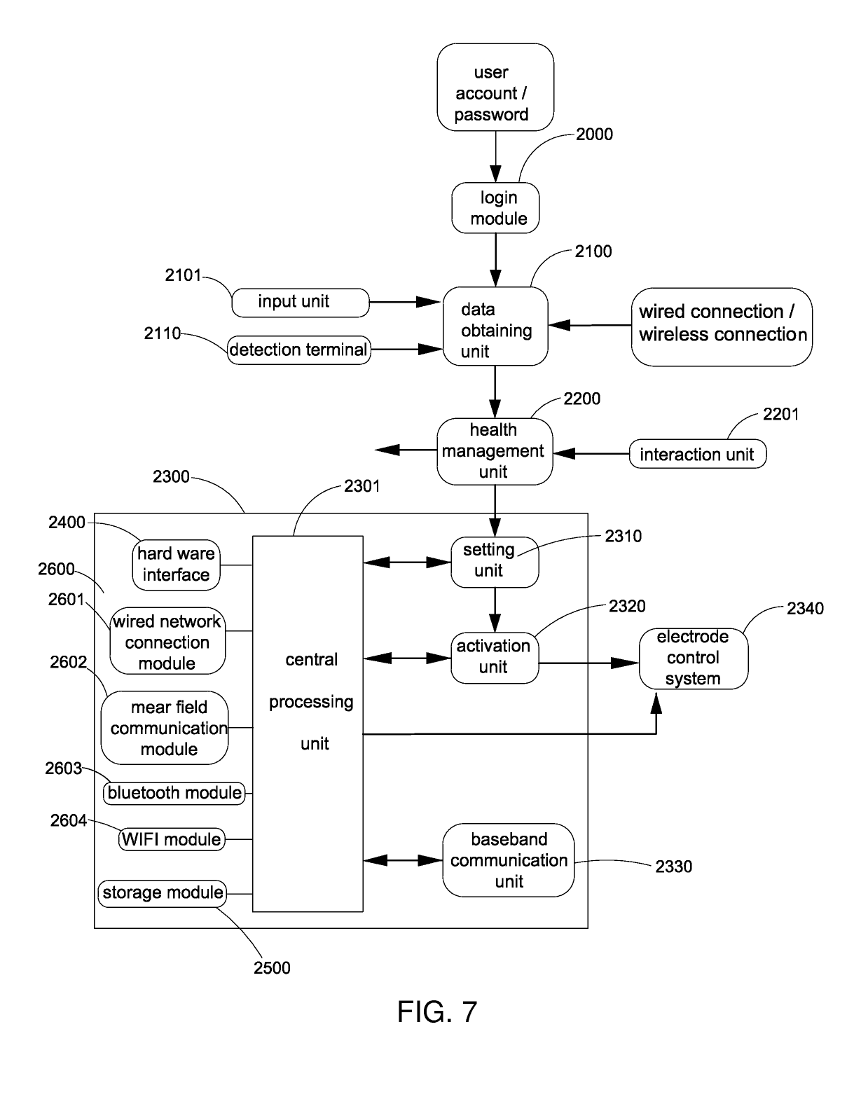

Referring to FIG. 7 of the drawings, an alternative mode of the above preferred second embodiment of the present invention is illustrated. The exercise monitoring system comprises login module 2000, data obtaining unit 2100, health management unit 2200, and exercise equipment 2300.

Accordingly, login module 2000, data obtaining unit 2100, and health management unit 2200 can be directly linked to or integrated with exercise equipment 2300.

The data obtaining unit may be provided with input unit 2101 and detection terminal 2110. Input unit 2101 is arranged for inputting the information to be processed. Accordingly, input unit 2101 can be embodied as a touch screen, keyboard, and so on. In an exemplary embodiment, the user may input telephone numbers or characters, receive a call, or read SMS messages through input unit 2101. Sending and receiving email can also be achieved by input unit 2101. It is worth mentioning that input unit 2101 can also be employed to set the operating parameters so as to control the operation of exercise equipment 2300. In particular, when input unit 2101 comprises a display unit, the preceding information is displayed on the display unit. Detection terminal 2110 is used to detect in real-time the information of exercise data and physical parameters from exercise equipment 2300.

Exercise equipment 2300 further comprises central processing unit 2301, setting unit 2310, activation unit 2320, baseband communication unit 2330 and electrode control system 2340.

Central processing unit 2301 can be, but not limited to, an ARM kernel processor of ARM Co. Ltd. Central processing unit 2301 controls the operation of exercise equipment 2300.

Setting unit 2310 sets up the operating parameters of exercise equipment 2300 based on the initial exercise data or health instruction provided by health management unit 2200. Accordingly, the operating parameters comprise, but not are limited to, velocity, resistance, duration, and energy consumption of the exercise item.

Activation unit 2320 activates exercise equipment 2300 based on the operating parameters. For example, exercise equipment 2300 is automatically initialized by activation unit 2320 after the confirmation of the user.

Baseband communication unit 2330 is used for the installation of a telephone SIM card. Accordingly, baseband communication unit 2330 cooperates with interaction unit 2200 so that real-time interaction, through telephone or even 3G video communication, can be achieved. For example, subscriber number, directory, SMS, MMS, and telephone history can be read so that communication for exercise equipment 2300 can be achieved. In particular, the user may open the directory and dial or send a message to one of the telephone numbers in the directory. It is worth mentioning that exercise equipment 2300 is further provided with a loudspeaker unit and a microphone unit for making calls as well as playing multimedia.

Electrode control system 2340 is used to activate the motor winding with respect to the initial operation of activation unit 2320. Alternatively, the activation operation of electrode control system 2340 can be directly activated by central processing system 2300.

In addition, in order to dynamically manage the initial health data and physical parameters, exercise equipment 2300 is further provided with hardware interface 2400, storage module 2500, communication module 2600 such as wired network connection module 2601, near field communication module 2602, Bluetooth module 2603, or WIFI module 2604.

The hardware interface may employ USB interfacing technology, so that portable storage medium can be linked with exercise equipment 2300 through hardware interface 2400 and thus the transmission, update, and backup of the initial exercise data can be achieved. Accordingly, the portable storage medium can be U disk, MP3, or MP4. Storage module 2500 is provided in exercise equipment 2300. When the user exercises on the same exercise equipment frequently, the storage module facilitates the management. It is worth mentioning that the initial exercise data and the physical parameters in the storage medium can be uploaded to the network server in real-time so that a portable management of the initial exercise data and the physical parameters of a wide range can be achieved.

Accordingly, wired network connection module 2601, near field communication module 2602, Bluetooth module 2603, and WIFI module 2604 respectively enables the user to transmit the initial exercise data and physical parameters fast and effectively. As mentioned above, the initial exercise data and the physical parameters can be uploaded to the network server, and then the initial exercise data and the physical parameters can be downloaded by other exercise item or other external device. Effective tracking and management of the initial exercise data and physical parameters is now achieved. Simultaneously, the real-time consultation or diagnosis can be ensured by the implementation of web phone, web video, or email.

In this preferred embodiment, login module 1000, data obtaining unit 2100 and health management unit 2200 can be incorporated into a portable device such as a cell phone, a portable computer, or a PDA. Therefore, when exercising or using exercise equipment 2300, the user may update the initial exercise data and the physical parameters through a cell phone or PDA. When login module 2000, data obtaining unit 2100 and the health management unit 2200 are integrated with exercise equipment 2300, logging into the web server can be achieved by means of the wired network connection module, the near field communication module, the Bluetooth module, and the WIFI module; additionally, data obtaining unit 2100 may serve to transmit the data.

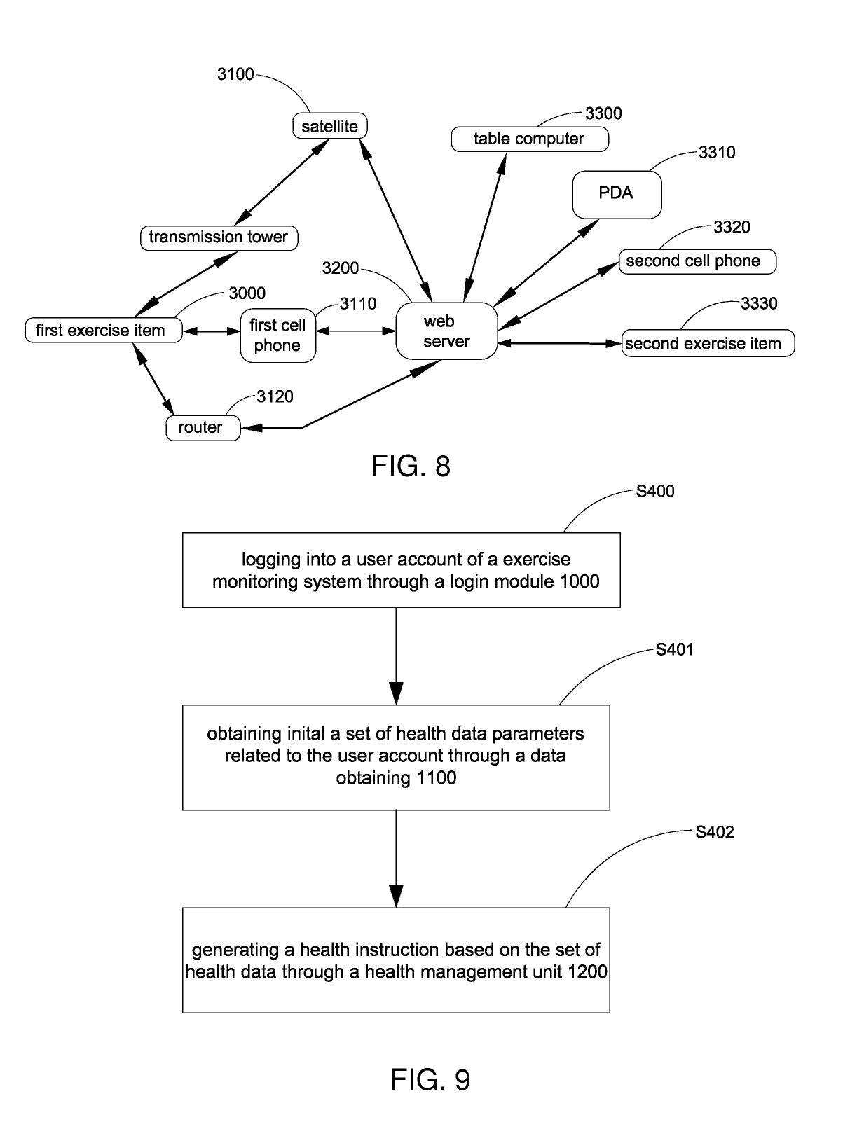

Referring to FIG. 8 of the drawings, the operation of the exercise monitoring system is illustrated. First exercise item 3000, a network connection device, web server 3200 and possible external devices are linked via wired or wireless connection. The network connection device comprises a transmission tower, satellite 3100, first cell phone 3110, router 3120, etc. The external devices may comprise tablet computer 3300, PDA 3310, second cell phone 3320, or second exercise item 3330. The specific number of these devices is not limited, for example, the external devices may comprise a plurality of second exercise items 3330.

When exercising with first exercise item 3000, the user can log into web server 3200 through the above mentioned network connection unit, or linked with a portable storage device through the hardware interface. The initial exercise data and the physical parameters are obtained, and the external devices may be employed for real-time consultation from the personal trainer.

In particular, when the user log into the exercise monitoring system with their user account or other logging manner, the initial exercise data and physical parameters in the local library are compared with the initial exercise data and physical parameters stored in web server 3200 so as to determine whether the initial exercise data and physical parameters in the local library should be updated. In other words, when the initial exercise data and physical parameter stored in the local library are the newest, the update is not required. When the initial exercise data and physical parameter stored in web server 3200 are the newest, the update is carried out. In addition, when a connection to web server 3200 is not successful, the initial exercise data and physical parameter stored in the local library are assumed to be the newest information.

Furthermore, other methods also can be used to store and update the initial exercise data and physical parameters. For example, when exercise equipment 2300 is not linked with web server 3200 and the information cannot be uploaded to web server 3200. A portable storage device such as a U-disk is employed to store the initial exercise data and physical parameters through the hardware interface. Then the update also can be achieved with the U-disk by downloading the initial exercise data and physical parameters into the local library.

Then the user can exercise under the guidance of the health instruction generated by health management unit 2200 or provided by the personal trainer through the interaction unit. Accordingly, the user may adjust these parameters by himself.

After exercising, the user may upload the data during this exercise to web server 3200, an external device, or other portable storage device, so that this data can be used as initial exercise data for the next exercise.

Referring to FIG. 6 and FIG. 9 of the drawings, a method for health monitoring comprises the following steps:

Step S400: log into a user account of an exercise monitoring system through login module 1000.

Step S401: obtain a set of health data related to the user account through data obtaining unit 1100.

Step S402: generate a health instruction based on the set of health data through health management unit 1200.

Accordingly, in the step S400, the user may use a QRCode, a membership card or physical features such as fingerprint or cornea. Alternatively, the user may input a username and a password for logging into the health monitoring system.

In the step S402, the health instruction is generated by health management unit 1200 which can be linked with a web server.

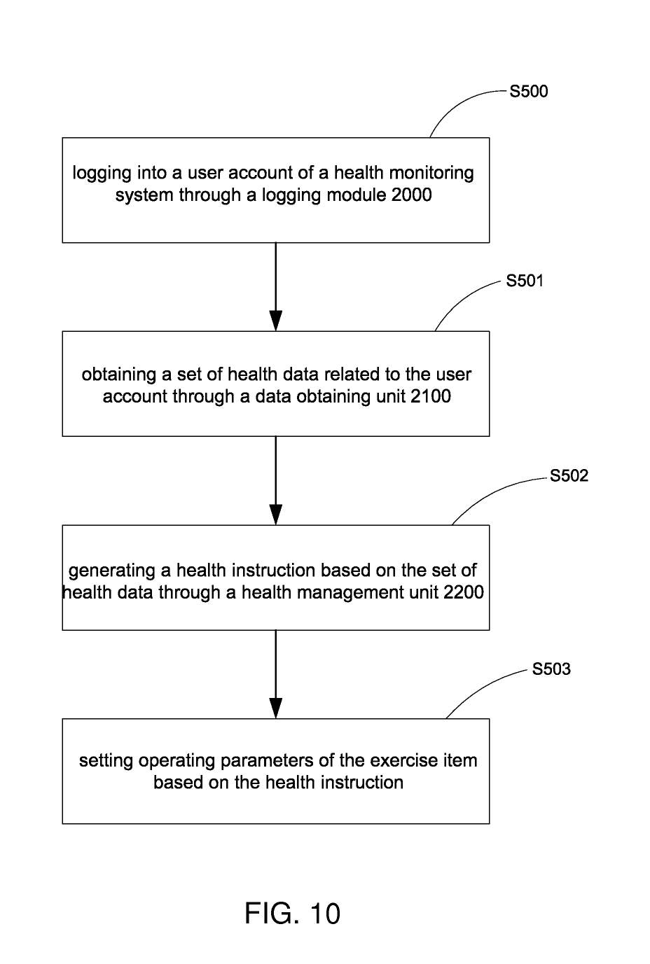

Referring to FIG. 7 and FIG. 10 of the drawings, when the exercise monitoring system is incorporated with exercise equipment 2300, the method for health monitoring comprises the following steps:

Step S500: Log into a user account of a health monitoring system through login module 2000.

Step S501: Obtain a set of health data related to the user account through data obtaining unit 2100.

Step S502: Generate a health instruction based on the set of health data through health management unit 2200;

Step S503: Set operating parameters of the exercise equipment based on the health instruction.

Accordingly, in the step S502, health management unit 2200 is provided with interaction unit 2201 through which the user may interact with a personal trainer for real-time consultation or diagnosis. In other words, the health instruction is provided by a personal trainer.

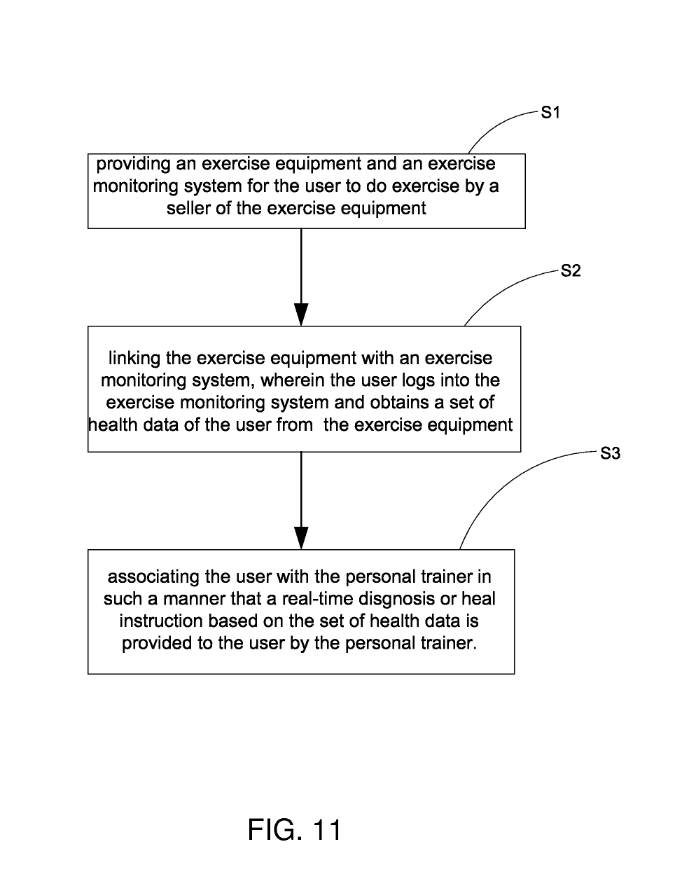

Accordingly, the present invention further provides a business method for at least one user of an exercise equipment, a seller of said exercise equipment, and a personal trainer of the user, wherein the method comprises the following steps, as shown in FIG. 11.

Step S1: Provide the exercise equipment and an exercise monitoring system for the user by the seller of said exercise equipment.

Step S2: Link the exercise equipment with an exercise monitoring system, wherein the user logs into the exercise monitoring system and obtains a set of health data of the user from the exercise equipment.

Step S3: Associate the user with the personal trainer in such a manner that a real-time diagnosis or heal instruction, based on the set of health data, is provided to the user by the personal trainer.

In the step S1, the exercise equipment is selected from the group consisting of, but not limited to, a rowing machine, fitness bike, walking machine, treadmill, waist machine and a physical testing machine.

In the step S2, the user uses a membership card, QRCode card, or username and password to log in the exercise monitoring system.

The step S2 further comprises a step: link the health monitoring system with a web server with wired or wireless connection, wherein the exercise data and physical parameters are updated and storied in the web server and can be downloaded to a local library of the health monitoring system.

The step S3 further comprises a step of selecting the desired personal trainer from a plurality of personal trainers by the user. This enables the user to choose his or her personal trainer from all over the world. Accordingly, the personal trainer may be an exercise instructor, fitness trainer, or expert of the exercise equipment. In another aspect, the personal trainer also can monitor the exercise of more than one users.

The user may interact with the personal trainer by making calls, sending message or email, or by video chat. Accordingly, the exercise monitoring system is provided with necessary input unit and network connecting unit such as wired network connection module, a near field communication module, a Bluetooth module, or a WIFI module.

The seller of the exercise equipment actually provides an interaction platform through the exercise monitoring system. The user and his or her personal trainer can interact with each other through the exercise monitoring system. When the user pays the personal trainer for the training and instructing, a percentage of the payment may be taken by the provider of the exercise monitoring system. In other words, the business method is beneficial for the user, the personal trainer, and the seller of the exercise equipment.

It is worth mentioning that the user may also interact with one or more personal trainers and receive advice from all of the personal trainers. A personal trainer also can monitor two or more users, and when a user needs help the personal trainer can interact with the particular user in real-time.

The method may further comprise a step of setting operating parameters of the exercise equipment so that the user exercises based on the operating parameters. In other words, the user can follow the advice and instruction of the personal trainer.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An exercise monitoring system, comprising:
a data obtaining unit arranged for obtaining a set of health data of a user, and
a health management unit communicated with said data obtaining unit for receiving said set of health data, wherein a health instruction is provided based on said set of health data through said health management unit for improving health of the user.

2. The exercise monitoring system, as recited in claim 1, wherein said health management unit is linked with a plurality of health statuses, wherein each one of said health status is arranged for reflecting one particular set of health data and is correlated to one said particular health instruction, wherein said health instruction is automatically generated in response to an input of said set of health data.

3. The exercise monitoring system, as recited in claim 1, wherein said health management unit comprises an interaction unit, wherein a personal trainer of the user interacts with the user to provide said health instruction.

4. The exercise monitoring system, as recited in claim 3, wherein said health instruction is a real-time diagnosis for the user from the personal trainer.

5. The exercise monitoring system, as recited in claim 2, further comprising a login unit through which the user logs into said exercise monitoring system and has access to the health monitoring unit, wherein the user has a user account registered in said exercise monitoring system.

6. The exercise monitoring system, as recited in claim 3, further comprising a login unit through which the user logs into said exercise monitoring system and has access to the health monitoring unit, wherein the user has a user account registered in said exercise monitoring system.

7. The exercise monitoring system, as recited in claim 4, further comprising a login unit through which the user logs into said exercise monitoring system and has access to said health monitoring unit, wherein the user has a user account registered in said exercise monitoring system.

8. The exercise monitoring system, as recited in claim 7, wherein the user uses a membership card, QRCode card, username and password to log into said exercise monitoring system through said login unit.

9. The exercise monitoring system, as recited in claim 7, wherein the user uses a physical feature of the user selected from the group consisting of fingerprint and cornea to log into said exercise monitoring system through said login unit.

10. The exercise monitoring system, as recited in claim 2, wherein said data obtaining unit further comprises an input unit arranged for the user to manually input said set of health data, wherein said input unit is selected from the group consisting of a touch screen, a keyboard, a write board, and a microphone.

11. The exercise monitoring system, as recited in claim 2, further comprising an exercise item for the user to do exercise, wherein said data obtaining unit and said health monitoring unit are linked or integrated with said exercise item, wherein said data obtaining unit further comprises a detection unit automatically detecting said set of health data generated from said exercise item on a real-time basis.

12. The exercise monitoring system, as recited in claim 11, wherein said exercise item is further provided with a central processing unit arranged for control an operation of said exercise item, a setting unit setting up operation parameters of said exercised item based on said health instruction, and an activation unit for activating said exercise item based on said operating parameters.

13. The exercise monitoring system, as recited in claim 11, wherein said exercise item is further provided with a baseband communicating unit for installing of a telephone SIM card, wherein said baseband communicating unit is linked with said interaction unit, whereby the user interacts with the personal trainer with telephone calls or SMS messages.

14. The exercise monitoring system, as recited in claim 11, wherein said exercise item is further installed with a loudspeaker unit and a microphone unit.

15. The exercise monitoring system, as recited in claim 11, wherein said exercise item is further provide with at least a hardware interface and a storage module, wherein a portable storage medium is employed to have access to said set of health data stored in said storage module.

16. The exercise monitoring system, as recited in claim 11, further comprising a network connection unit provided for communication between the user and the personal trainer, wherein said network connection unit is selected from the group consisting of a wired network connection module, a near field communication module, a Bluetooth module, and a WIFI module.

17. The exercise monitoring system, as recited in claim 10, wherein said exercised monitoring system is incorporated into a portable device selected from the group consisting of a tablet computer, a PDA, and a cell phone.

18. The exercise monitoring system, as recited in claim 11, further comprising a web server linked with said health management and said data obtaining unit in a wired connection or wireless connection, wherein said heal data and said health instruction are stored and updated in said web server for the user to download.

19. The exercise monitoring system, as recited in claim 11, wherein the personal trainer is selected from the group consisting of a health instructor, a fitness trainer, and an expert of said exercise item.

20. The exercise monitoring system, as recited in claim 19, wherein said health data comprises operating parameters of said exercise item and physical parameters of the user.

21. An exercise monitoring method, comprising the following steps:
(a) generating a set of health data for a user through a data obtaining unit, and
(b) interactively linking said data obtaining unit with a health management unit, wherein said health monitoring unit is used for providing a health instruction based on said set of health data.

22. The exercise monitoring method, as recited in claim 21, further comprising a step of associating with the user with a personal trainer through an interaction unit of said health management unit on a real-time basis.

23. The exercise monitoring method, as recited in claim 21, wherein the step (b) further comprises a step of automatically generating said health instruction from said health management which is linked with a plurality of health statuses, wherein each one of the health status is arranged for reflecting one particular set of health data and is correlated to one particular exercise instruction.

24. The exercise monitoring method, as recited in claim 21, wherein the user is communicated with the personal trainer in a wired connection or wireless connection.

25. The exercise monitoring method, as recited in claim 22, further comprising a step of setting operating parameters of said exercise item based on said health instruction from the personal trainer.

26. A business method for at least one user of an exercise item, a seller of said exercise item, and a personal trainer of the user, wherein the method comprises the following steps:
(a) providing said exercise item and an exercise monitoring system for the user by the seller of said exercise item;
(b) linking said exercise item with an exercise monitoring system, wherein the user logs into said exercise monitoring system and obtains a set of health data of the user generated from said exercise item when using said exercise item; and
(c) associating the user with the personal trainer in such a manner that a real-time diagnosis or heal instruction based on said set of health data is provided to the user by the personal trainer.

27. The business method, as recited in claim 26, further comprising a step of linking said health monitoring system with a web server in a wire connection or wireless connection, wherein said set of health data is stored and updated in said web server.

28. The business method, as recited in claim 26, wherein the interaction of the user and the personal trainer is implemented on a real-time basis.

29. The business method, as recited in claim 26, wherein the personal trainer is selected by the user from a plurality of personal trainers at different locations.

30. The business method, as recited in claim 26, wherein said step (c) further comprises a step of associating the user with the personal trainer via telephone calls, SMS messages, emails, or video chat.

31. The business method, as recited in claim 26, further comprising a step of providing a user account by said seller for the user, wherein the user uses a membership card, QRCode card, or username and password to log into said user account in said exercise monitoring system.

32. The business method, as recited in claim 21, further comprising a step of charging a percentage of a payment from the user to the personal trainer by the seller.
